(19) United States
(12) Patent Application Publication
(10) Pub. No.: US 2005/0154648 A1
(43) Pub. Date: Jul. 14, 2005

(54) Interactive lead generation system having a web-based application for reporting and following up with leads and methods of use thereof

(76) Inventor: Todd M. Strause, Louisville, KY (US)

Correspondence Address: Douglas W. Schelling;Wyatt, Tarrant & Combs, LLP, Suite 800, 1715 Aaron Brenner Drive, Memphis, TN, 38120-4367, US

(21) Appl. No.: 10/979,983

(22) Filed: Nov. 3, 2004

Related U.S. Application Data
(60) Provisional application No. 60/517,205, filed on Nov. 4, 2003.

(51) Int. Cl. G06F 17/60

(52) U.S. Cl. 705/26

(57) ABSTRACT

An interactive method and web-based system to provide information to leads generated by different forms of advertising and to provide these leads to the client's knowledge to use in the sale of products. The system gathers information in various ways about customers through telephone calls in which information is gathered using audio and DTMF input that is then stored in a relational database to help the client maximize the usefulness of the lead. Interaction with the lead is via the website. All variable data used in the program is stored in a database. The IVR script is built dynamically using snippets of pre-recorded audio played in a sequence along with audio generated by a text-to-speech (TTS) engine. Once the call is completed, the web based system notifies the client of the presence of a new lead via fax and/or email. The client can elect to use the follow-up mail piece to be sent immediately to make sure the customer gets the information from another source, instead of just the IVR system. The information provided by the customer during the phone call is stored in a database and accessed via a web-based program to analyze the data of each customer and this allows the client to run respective reports which will provide information on balancing inventory, various customer activity reports by date and time, geographic location of customers, and the like.

This application claims benefit of U.S. Provisional Patent Application Ser. No. 60/517,205, filed Nov. 4, 2003, entitled “Lead Generation System With a Web-Based Application for Tracking, Reporting and Following Up with Leads” which is hereby incorporated by reference.

Be it known that I, Todd M. Strause, a citizen of the United States, residing at 2003 Arnold Palmer Blvd., Louisville, Ky. 40245, have invented a new and useful “Interactive Lead Generation System Having a Web-Based Application For Reporting and Following Up with Leads and Methods of Use Thereof.”

### FIELD OF THE INVENTION

The present invention relates to sales of items, such as automobiles, real estate and the like, and more particularly to a web-based interactive system that provides customers with product information while simultaneously providing a reporting and follow-up system to allow thorough follow-up on leads generated through all forms of advertising.

### BACKGROUND OF THE INVENTION

Automobile dealers spend thousands of dollars each month on newspaper, television, direct mail, internet and other forms of advertising in order to attract customers to call or visit their dealership. If an individual is enticed by the offer, but reluctant to call or visit the dealership, the potential for a sale cannot be realized. Many individuals are reluctant to start their search for a vehicle by contacting the dealership directly because they are not comfortable with the selling techniques practiced by dealerships. Instead, they turn to less informative methods such as after-hours visits to the dealership and studying advertisements to get an idea for the type of vehicle they are interested in. Because of this, the potential customer loses the ability to obtain full information about the vehicles or other vehicles available to them. After a potential customer selects a vehicle, they will often use the resources of libraries, automobile books or the internet to obtain additional information without fully understanding the possibilities that could be available.

If the dealer knew that a particular person was currently interested, they may be able to help find the right vehicle. Their recommendations would be even more effective if a dealer further knew which vehicles interested the person. The dealer may be able to make recommendations the buyer never considered.

In addition to factors such as price or gas mileage, today's cars have many features and options available. The presence of a particular option may be a deciding factor in the purchase of a vehicle. However, the details of the particular vehicle seen in the media or on the dealership lot are sometimes difficult to obtain without the direct contact. More importantly, the dealer is often unaware that a particular person is interested in purchasing. This is because the person is viewing the inventory or product and gaining limited information either when the store is closed or using other media.

Attempts have been made to address the foregoing problems. Those references include U.S. Pat. No. 5,883,940, issued to Thornton on Mar. 16, 1999, and U.S. Pat. No. 6,097,792, issued to Thornton on Aug. 1, 2000 (a divisional of U.S. Pat. 5,883,940), which are incorporated herein by reference. The use of caller I.D. has several drawbacks. Caller I.D. is inaccurate 2 to 6% of the time, can be selectively blocked by the caller, and provides only the phone number of the caller. Even if a system does a reverse look-up into a database in order to match the caller I.D. to the name of the person who is assigned to that particular telephone number, the customer who is calling may not be the person who the telephone number is assigned to, which results in an improper identification. Additionally, caller I.D. cannot identify calls made from cellular phones. This is a significant drawback, and will become even more significant as the percentage of calls placed from cell phones continues to increase. Further, when a person records their own 30 to 40 second message describing a product, problems such as dialect, mumbled wording or recording errors can detract from the recorded description and result in loss of information.

There is a need for an improved interactive lead generation system that combines IVR and web-based technologies to provide customers with product information, in the manner described herein. The invention is designed to capture information from a prospective buyer and pass said information along to the client. The client will run a set promotion and be provided with a toll-free number (TFN) unique to the type of promotion. This TFN is based on the program, not the dealership. So the same program can be run among several different clients using the same TFN. Additionally, the medium of the program such as a mailed letter, sticker, or advertisement in the media is uniquely encoded. In this way, the exact client that initiates the campaign, the product of interest and/or the calling party can be identified at the start of the call.

### SUMMARY OF THE INVENTION

The present invention provides a system and method of use thereof for generating sales leads. Briefly, the method includes the steps of receiving contact information for a potential customer, providing product information to the potential customer, storing the contact information of the potential customer, forwarding the contact information to a third party, and generating follow up correspondence to the potential customer.

In certain embodiments of the invention, the method includes providing a plurality of product codes, storing each said product code in association with product information about a product item of a client of the system, said product information comprising textual information, providing a telephone number, said telephone number providing access to an IVR server, recording a textual greeting in a database, said database accessible to said IVR server, processing a plurality of telephone calls received from customers via said telephone number, each said processing step further including playing a verbal customer greeting to the customer, said customer greeting soliciting input from the customer, receiving, in response to said customer greeting, a textual set of customer contact information from the customer via customer input using a key pad of the customer's telephone, storing said textual set of contact information, receiving, in response to said customer greeting, a verbal set of customer contact information from the customer via the customer speaking into the customer's telephone, storing said verbal set of customer contact information in a voice clip, receiving, in response to said greeting, one or more selected product codes from the customer, the customer selecting said product codes via customer input over the customer's telephone, in response to each said selected product code, playing verbal information about said product item associated with said product code to the customer, wherein said playing of information is accomplished by said system converting said textual information about said product item into a verbal format, providing a plurality of clients with login access to said system.

Additional embodiments of the above-mentioned invention include the textual set of customer contact information further including the customer's telephone number and zip code, wherein the verbal set of customer contact information further comprises the customer's name, address, and telephone number. In certain embodiments, the product codes are 4-12 digits. In still other embodiments, the product codes are nine digits. In other embodiments, the product codes further include an initial sequence of four of the nine digits identifying a particular client of the interactive system and a remaining sequence of five of the nine digits identifying a product item of the particular client. In still other embodiments, the method further includes manually processing each verbal set of customer contact information in order to convert the information into a textual format, and associating the textual format with the customer in the system. In still other embodiments of the invention, the method further includes mailing the customer information about the product items that the customer selected during the telephone call via input of the product codes.

In other embodiments of the invention, the method includes receiving a telephone call of a user; receiving a product code entered by the user; validating the product code against product codes in a database; collecting information from the user; storing the information from the user in the database; forwarding the information to a client, wherein the information is forwarded in textual form; providing product information to the user by a voice message; and terminating the telephone call. In other embodiments of the invention of this paragraph, the information forwarded in textual form further comprises forwarding an email.

In other embodiments of the invention, the method includes receiving a telephone call by an interactive voice response server; providing verbal information to the caller from the interactive voice response server; contacting a web server by the interactive voice response server; building script by the web server; receiving caller information, wherein the caller information further comprises a product number; validating the caller information by the web server; storing in a database the caller information; and sending the caller information to a client.

In other embodiments of the invention of the above-paragraph, the method further includes entering verbal information by a client. In yet other embodiments, receiving a telephone call further includes receiving a plurality of telephone calls simultaneously. In still other embodiments, the caller information further includes a contact telephone number, and contact mailing address. In still other embodiments, the method further includes preparing a follow up letter to the caller from the client.

Accordingly, one provision of the present invention is a method obtaining contact information from a consumer considering the purchase of a specific product.

Another provision of the present invention is a method of storing and forwarding contact information for a consumer that is determining whether to purchase a specific product.

Still another provision of the present invention is a method of automatically generating follow up correspondence to a consumer that has made an inquiry about a specific product.

Another provision of the present invention is a method of generating a database of consumers having an interest in purchasing a specific product.

### BRIEF DESCRIPTION OF THE DRAWINGS

FIG. 1A is a flow diagram of an embodiment of the invention.

FIG. 1B is a flow diagram of another embodiment of the invention.

FIG. 1C shows the interrelation of the IVR server, web server, and database of the present invention.

FIG. 2 is an exemplary direct mail advertisement form which allows the client to advertise the toll free number and unique product code to entice the customer to call the system.

FIG. 3 is a sample of a classified ad placed in print media for use with the interactive system of the invention.

FIG. 4 is a flow diagram of an embodiment of the follow up system of the present invention.

FIG. 5A is an exemplary side addendum tag which may be placed on each vehicle for use with the interactive system of the invention.

FIG. 5B is a window sticker which will be placed on each vehicle to draw attention to the side addendum previously mention in FIG. 5A.

FIG. 6 is a flow diagram showing an embodiment of the invention.

FIG. 7 is a flow diagram showing another embodiment of the invention.

FIG. 8A is a flow diagram showing an embodiment of the invention.

FIG. 8B is a flow diagram showing an embodiment of the invention.

### PREFERRED EMBODIMENTS OF THE INVENTION

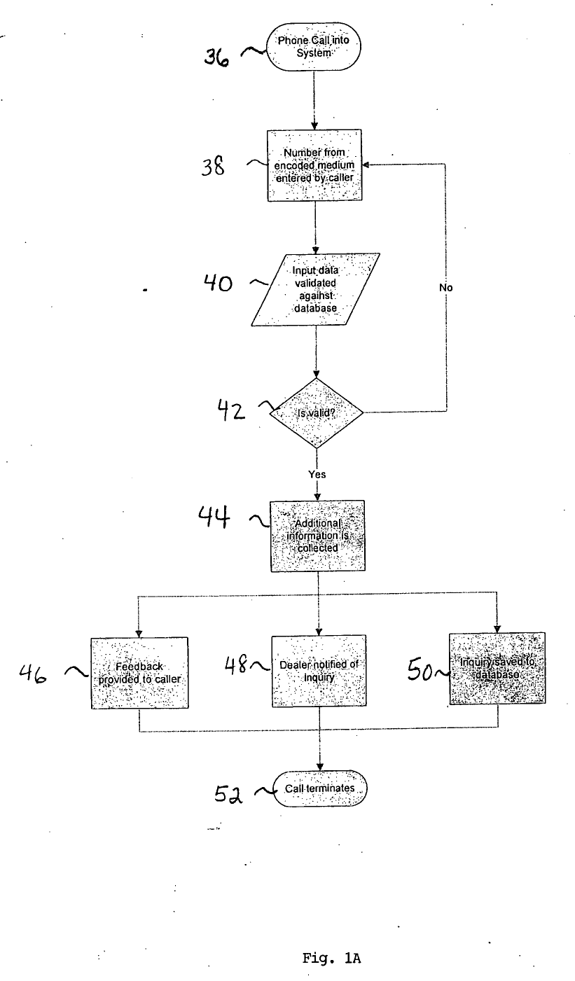

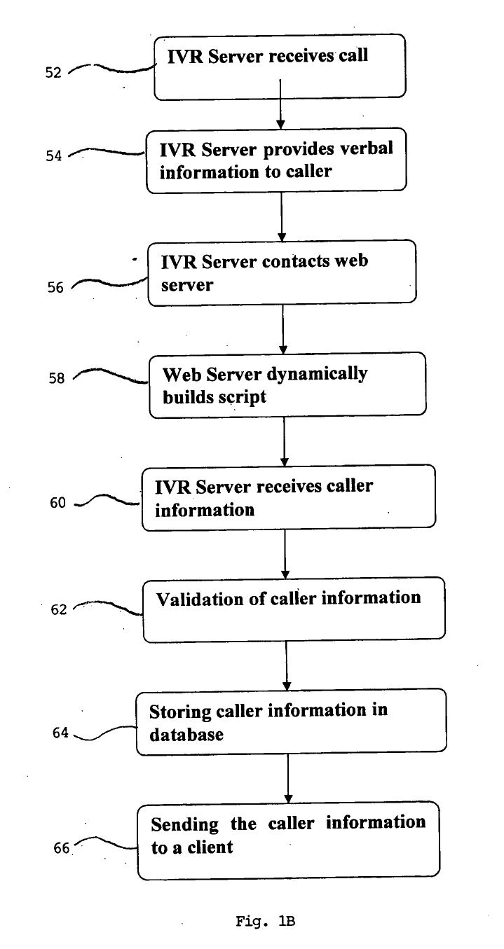

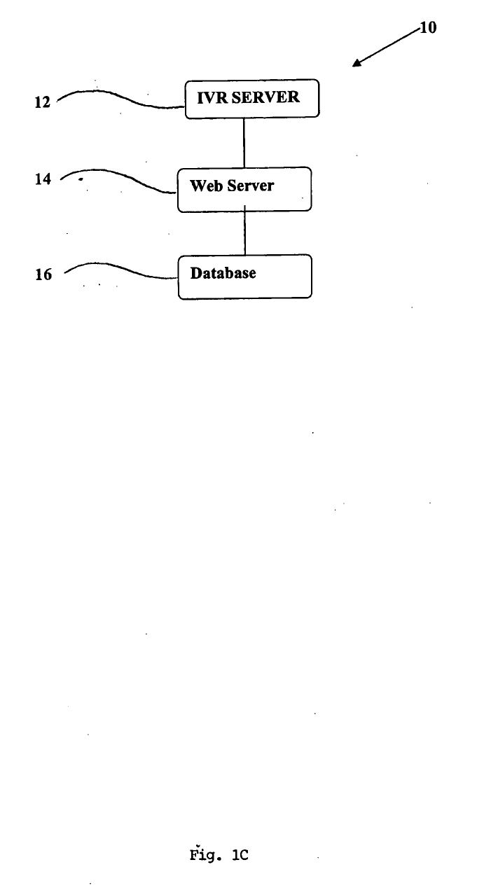

The present invention provides a system and method of use thereof to report a sales lead and provide a follow up contact. The interactive web based system 10 includes at least an interactive voice response server (IVR server) 12, a web server 14, a database 16, as seen in FIG. 1 C. The system 10 also includes a telephone number 18, a product code 20, and product information 22 about a product 24. As further described herein, the method of using the system 10 includes receiving a telephone call from a user, receiving a product code 20 from the user, receiving contact information for the user, providing product information 22 about a product 24 to the user, and forwarding the user contact information and product information requested to a third party, such as the client selling the product 24.

The interactive web based system 10 for the generation of leads and follow up of those leads of the present invention may be referred to generally as Strategic Lead Generation (SLG). As used herein, “client” refers to a primary user of the SLG, such as an automobile dealer or real estate agent. The client is the party that is providing the product 24 and will benefit from the lead generated. “Customer” refers to a secondary user of the SLG, such as a customer, consumer, or visitor to a client's business, such as an automobile lot. A customer may also be referred to as a user. A “customer” is also a consumer that reviews advertising, such as newspaper advertising, direct mailings, television advertising and the like.

SLG is composed of two main components, an IVR server 12 and a web server 14. Both servers are well known in the art and are widely commercially available. For example, an IVR server 12 is commercially available from Voxeo IVR Server, of Orlando, Fla., a web server 14 is commercially available from Dell Optiplex, of Round Rock, Tex., and a database 16 is commercially available from Microsoft SQL Server, of Redmond, Wash. Setting up and using an IVR server 12 and web server 14 is known by one of ordinary skill in the art. Further, connecting the hardware disclosed herein for information exchange is also well known in the art. The purpose of the IVR server 12 is to receive an incoming call from a customer. The web server 14 is accessed by the IVR server 12 to dynamically generate, or build, the call script. This is referred to as voice browser technology. The method of retrieval and playback is the World Wide Web Consortium (W3C) approved VoiceXML (VXML) technology. Additional information on the standards for VXML is maintained by the W3C, as known by one of ordinary skill in the art.

Before the system 10 receives a call, the product code 20 for each product 24 must be loaded into the database 16. In certain embodiments, in addition to the product code 20, additional information, such as price, expiration dates of purchase incentives or other characteristics may be associated with the product code 20 so the product information 22 may be provided to a customer. Loading the product code 20 and additional information may be accomplished by converting the product code 20 and additional information into a predetermined file structure and saving the data file. Various file structures are well known in the art. These steps are well known in the art and are easily completed by one of ordinary skill in the art. The file is then parsed, checked for completeness and accuracy, and loaded into the database. This process is automated and does not require manual entry of each item. However, as further described herein, a method does exist to edit existing entries or add other product codes 20.

When the web server 14 receives a request from the IVR server 12, a dynamic script is built. This may be accomplished by using the customer contact information received from the IVR server 12, which may be obtained as further described herein, and may include the telephone number 18 called by the customer and the product code 20 entered by the customer. Each active phone call may be referred to as a session. The customer contact information collected from the customer, also known as the caller, during the phone call is accessible to both the IVR server 12 and web server 14 during this session. That customer contact information may be referred to as variables. The web server 14 uses decision logic and these variables to dynamically build script which is then returned to the IVR server 12. Use of decision logic to dynamically build script is well known in the art and may be accomplished by one of ordinary skill in the art. By way of example, the system 10 uses a product code 20 located on a mailing to entice a customer to register for a prize and place a call. As stated above, the prize associated with each product code 20 may be stored in a database 16. After a caller enters the product code 20, information regarding the corresponding prize may be read to the caller. Further, the date, time and ANI of the call can be stored in the database. As another example, if the customer calls a second time and enters the same product code 20 previously entered, then the script changes to inform the caller that the entry has already been activated. In further examples, the system 10 may reiterate the name of the company sponsoring the contest and any relevant rules. Since the script is dynamically driven it can be changed even in the middle of the campaign by either updating the database or editing the web pages used to render the WVR script.

Unlike prior art systems, the interactive system 10 provides access for multiple customers by using a single telephone number 18 and makes use of text-to-speech technology to provide a system 10 that is simple and economical to use. The interactive system 10 uses telephone calls from customers to generate sales leads and creates a customer database 16 for clients of the system 10, while simultaneously providing product information 22 to customers. The invention is directed primarily to capturing prospective buyers and passing information onto the clients. Although the system 10 will be described in terms of automobile dealerships, it will be apparent that the system can be used with other types of products. The system lends itself to use with big-ticket items such as automobiles and houses, but the system can be used in any sales situation in which the information and additional sales generated by the system 10 increase profits sufficiently to justify the administrative and financial costs of using the system 10. Because the system 10 is fully automated, the administrative and financial costs of using the system are relatively low.

The IVR server 12 can handle multiple simultaneous calls from any phone channel. Based on the toll-free number (TFN), or telephone number 18 that is dialed by the customer to initiate a call, a web page is retrieved from the web server 14. At that moment, the telephone number originating the call (ANI), meaning the telephone number of the customer, and the telephone number 18 dialed by the customer are passed to the web server 14. Based on the page accessed, the vocal script for the call is passed back to the IVR server 12 for voice rendering. Voice rendering is the process by which the IVR server 12 uses the information in the retrieved page to assemble pre-recorded audio files and text-to-speech rendered items into an audio signal to play back to the caller, or customer. Voice rendering is well known in the art and is understood by one of ordinary skill in the art. The pre-recorded audio files are stored on the web server 14 along with the web pages. During playback of the script, the caller will be asked to provide additional information. All information entered by the caller is ultimately stored in a database 16 on the web server 14 for later retrieval via ad-hoc query generators or graphical user interfaces.

Before an advertising campaign begins, each product 24, or item that is to be made available for inquiry is given a unique identification code, also called a product code 20. In certain embodiments, the product code 20 has nine digits. In alternate embodiments, the product code 20 has from about four digits to about twelve digits. This product code 20 is given to the advertising dealer, or client, so that it may be distributed to customers. This product code 20, product information 22, which is an item description, the associated client, and additional item specific information are loaded into a database 16 as described above. The client that is running the campaign has the ability to enter custom text to be played in addition to pre-recorded audio files. Then, a potential customer makes an inquiry via telephone. The system 10 provides verbal information to these customers, thus servicing customers that would otherwise not receive complete information about the products 24, in this case vehicles, that they are interested in. The information gathered as a result of the call is passed on to the client, such as an automobile dealership. At that point, the client uses a web based system to manage all contact with the lead. The system 10 provides various features that can be used in advertising the client's products 24. As further described below, the system 10 is set up to receive several calls at one time and to process and store all collected data in an organized manner. Accordingly, advertising is not required, because clients can elect to rely on location traffic (i.e. visits to the dealer's lot) to generate calls.

Using the standard telephone network, a toll-free number (TFN), or telephone number 18, is assigned to each program, or advertising campaign. This TFN is unique to the type of promotion, not the client. When a customer calls the system 10, the IVR server 12 reads the initiating TFN 18. Based on a lookup in the IVR server 12, a call is made to the web server 14. At that point, the only information available to system 10 is the customer's telephone number and the telephone number 18 called by the customer, which is related to the specific advertising campaign being accessed. At this time, this information is not complete because the owner of the item that sparked the interest for inquiry is unknown.

Once the advertising campaign, or program, has been identified, the script to be used by the IVR server 12 is dynamically built by the web server 14, as described above, and returned to the IVR server 12 in a properly formatted VXML document. VXML documents are well known in the art and the generation and use thereof are known by those of ordinary skill in the art. The IVR server 12 uses the VXML document to determine the resulting audio stream, call flow and points of data collection. This script also contains the actions to take based on erroneous entries, disconnects or malformed data entry. Additionally, the script can be customized by the client running the program by using flags in the database 16 to change page retrieval location and text-to-speech (TTS) blocks inserted in to the script that the web server 14 uses when dynamically constructing the page.

Once the program has been identified, the caller will be instructed to enter the encoded number, also called the product code 20, of the product 24 they are inquiring about. This entry may be read back to the caller for verification that the product code 20 received for processing is the product code 20 the caller intended. The caller may be given a predetermined number of chances to enter the correct code before the system disconnects the call so as to conserve resources. Once the caller validates their entry, the product code 20 is passed from the IVR server 12 to the web server 14 for validation. The web server 14 validates the entry from the caller against the database 16 of valid entries. At this point, one of two results will occur. If the product code 20 is invalid, the script alerts the caller to an invalid entry and prompts re-entry. The caller may be given a predetermined number of chances to enter the correct product code 20 before the system 10 disconnects the call so as to conserve resources. Alternatively, if the product code 20 is valid, the script continues. Based on a valid entry, a new page is dynamically created. Since each product code 20 is linked to a client, it is possible for the inquiry to be directed to the appropriate party from this point in time until the call ends. This is important in case the caller disconnects before all the additional information is gathered or the script has completed and the call terminated.

Based on the advertising campaign running, the customer, or caller, may be asked to supply contact information. Examples are: a home phone number in case the number they are calling from is not their home, a recorded voice clip of their address, or their home ZIP code for demographic measuring. These are merely examples and are no way meant to be a complete list of possibilities. It is important to note that the dynamic nature of the script is further enforced by the web server's ability to dynamically build the VXML based on input as the script progresses. At the end of the script, the IVR server 12 disconnects the call.

After the call is terminated, all gathered data is saved to the database 16 for storage. At that point, the customer and customer contact information are referred to collectively as a lead. In addition, notification is sent to the client that an inquiry has been made. Using a web based interface, the client is then able to interact with this newly obtained lead. The system 10 allows for a centralized location to store notes on the individual, record dates and times of contact as well as scheduled appointments. The client can use this information to assist them in closing a deal, maximizing the potential of each lead, identifying trends, rewarding salesperson performance or increasing advertising performance. Additionally, this system 10 can be used for follow-up calls based on categorizing a lead. It is possible an individual is not interested today, but will be in the future. The system 10 archives this information so that the client again has a centralized location to store their information for retrieval at a later date.

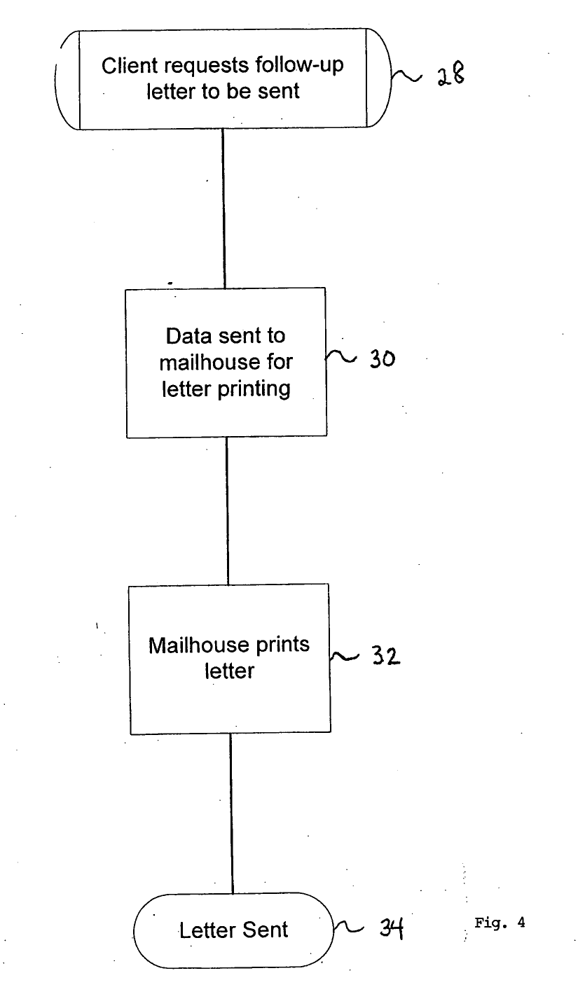

In FIG. 4, it is shown for each lead captured into the central database, the client can elect to send a follow-up mailing to the customer's address. The system is preferably configured such that the mail out is automatically prepared by the system, thus relieving clients of this administrative task. Each client can select whether to participate with the automatic mail out function. The mail out can take various forms according to preferences of the client (e.g. letter, memorandum, flyer). Specifically, the steps include that the client requests 28 that a follow-up letter be sent, the data is sent 30 for letter printing, the letter is printed 32, and the letter is sent 34. The mail out contains product information that the customer requested through entry of codes. The mail out preferably contains the customer's contact information, date of call placed, and time of call. Again, this invention is designed to deliver “information to” and “capture information from” a prospective buyer and pass said information along to the client.

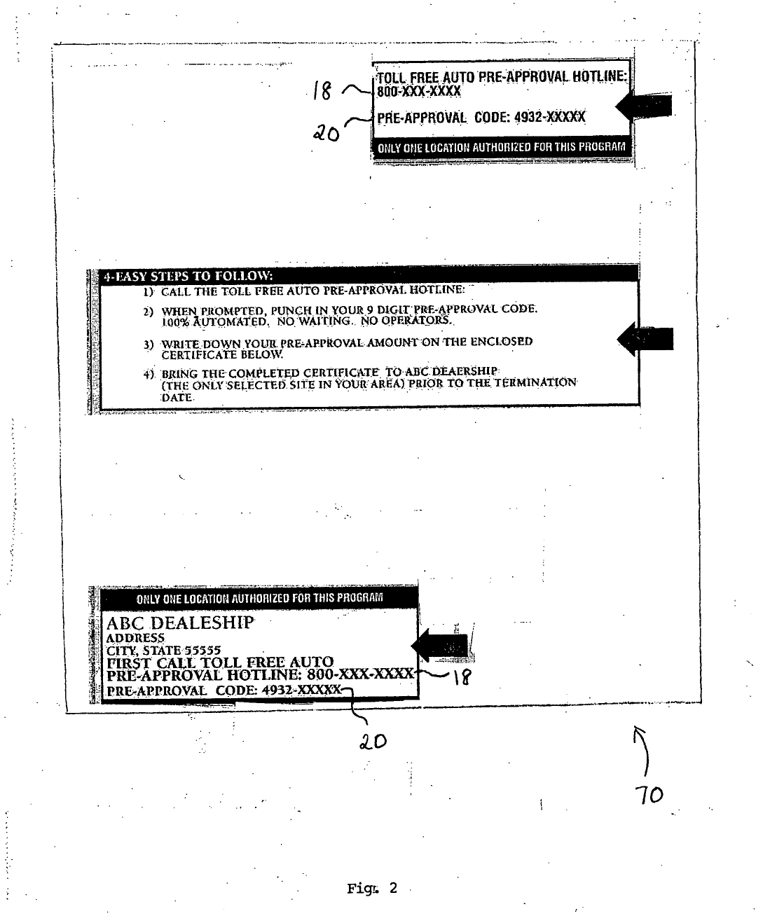

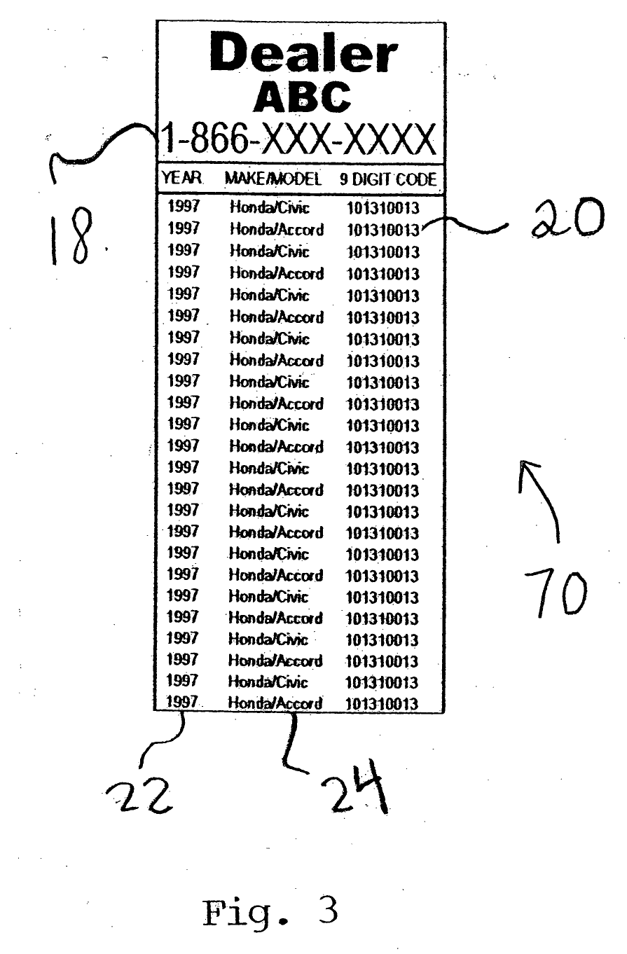

Regarding FIGS. 2 and 3, there are provided examples of print and direct mail advertisements 70 that take advantage of the features of the invention. The print advertisement of FIGS. 2 and 3 include a telephone number 18 that a customer can call to access the interactive system 10. As previously mentioned, this telephone number 18 is preferably the only telephone number 18 that allows customers to access the system for each program. The print advertisements of these figures include the product code 20 for the particular product 24. The advertisements also include enough information about the product to generate customer interest (i.e. '99 Ford Taurus, 15 k miles, automatic), so that the customer will call the telephone number. Note that the classified ad takes up very little space, and is therefore economical. Note that additional advertisements may provide a more detailed print ad that includes pictures of the vehicles and the name of the dealer. However, the use of the telephone number 18 and product code 20 allows the advertisement in FIG. 3 to contain less information, and therefore be more economical than conventional automobile print advertising.

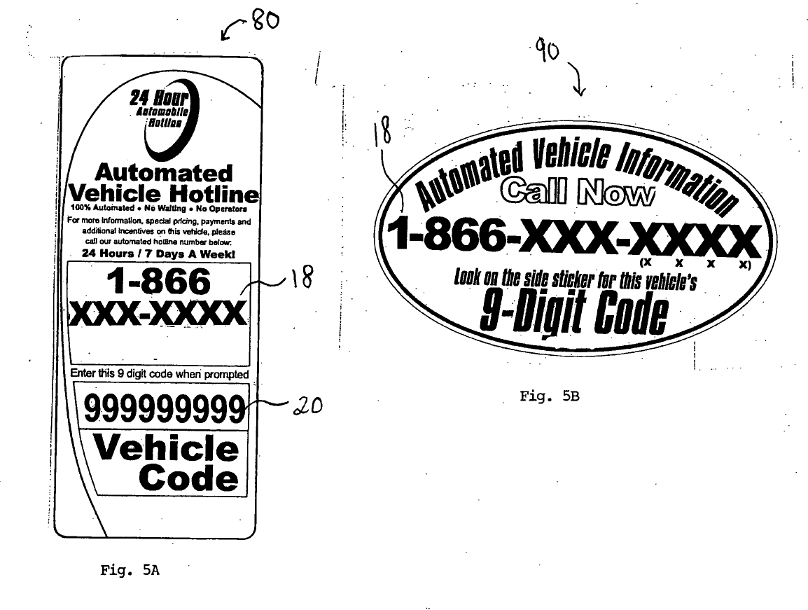

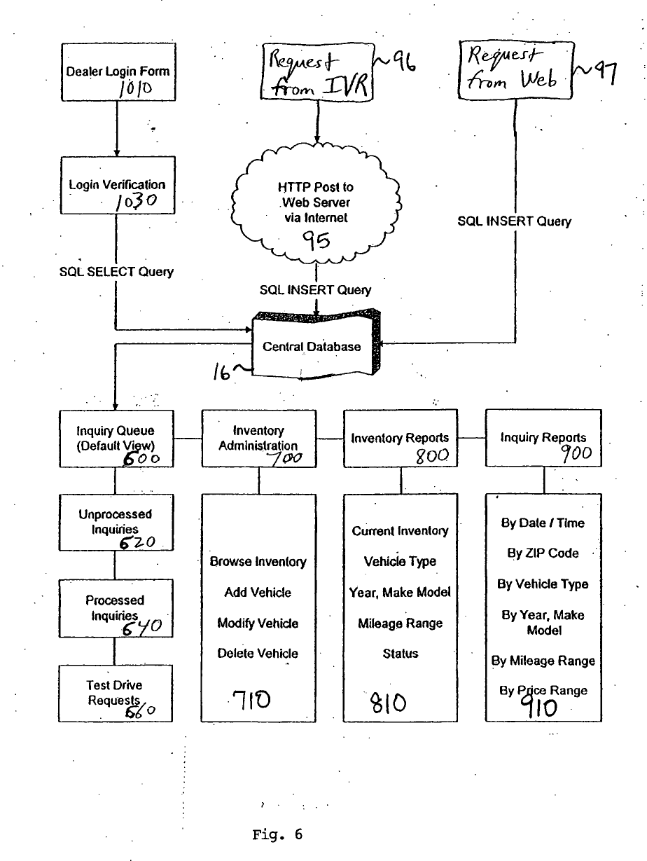

The tag information that must be provided for new vehicles is established by law and cannot be altered. However, tags for pre-owned vehicles can be modified to provide limited information about the vehicles, such as year, make, model and stock number. Providing limited tag information will encourage customers to call into the interactive system 10 using the telephone number 18 in order to obtain additional information. The vehicle side addendum 80, shown in FIG. 5A provides all of the information necessary to entice a customer to call into the system 10. Each vehicle in inventory may also be provided with a large window sticker 90, as shown in FIG. 5B, that states something to the effect of: “If you would like more information on this vehicle, please call our 24 hour/7 day a week, 100% Automated Hot-Line.” In the side addendum 80, shown in FIG. 5A, this information is also provided.

As shown in FIGS. 1A and 1B, the interactive system 10 uses a web-based application which is tied to an Interactive Voice Response (“WR”) system 12. Briefly, as shown in FIG. 1A, a call is received 36, product code 20 is entered by the caller 38, the code is validated 40, 42, additional information is collected 44, and information is provided to the caller 46, the client is notified of the inquiry 48, information regarding the inquiry is saved 50 to the database 16, and the call is terminated 52. With regard to FIG. 1B, the IVR server 12 receives a call 52 and provides information to a caller 54, the IVR server 12 contacts 56 the web server 14, the web server 14 builds script 58, the IVR server 12 receives 60 caller information, the caller information is validated 62 and stored 64 in a database 16, and the caller information is sent 66 to a client.

The system 10 captures information from the leads through questions that are asked of the customers when they call the IVR server 12. The interactive system 10 captures voice recording clips of answers and interactive presses of the telephone key pad, along with each and every product code 20 the customer entered for more information. This relevant information is instantly updated to the central database 16 while the phone call is connected to the system 10. An electronic mail will be sent to the client and relevant parties about the customer. In alternate embodiments, a facsimile will be sent to the client. From the actions that the caller takes, information is compiled and updated in the central database 16 for reporting activity which will analyze where the customers are responding from, the most popular times calls are being placed, the most active days for customer telephone calls, and other reports.

In certain embodiments, product information 22 may be entered into the web based system 10 through a special submission form through the protected client area. This product information 22 will allow reports to be run, for example, to analyze existing inventory, price ranges of inventory, mileage ranges, colors, type of vehicles (such as passenger cars or trucks), etc. These reports also allow the client to move inventory in and out of the system 10 and allows them to track sold vehicles, and available vehicles. The clients are able to prepare a list of the most popular vehicles in which information is being accessed from the end user.

The interactive system 10 is based on a foundation of an IVR server 12 connection and how it gathers data. As will be described in further detail below, the interactive system 10 of the invention handles or processes multiple telephone calls from individual customers who are seeking additional product information 22 about products 24, for example vehicles, that they are interested in while visiting the dealership's lot.

Specifically, with regard to automobile dealers, due to economic constraints, dealerships do not provide salespeople during an entire 24 hour day. Additionally, when business is heavy, a dealership may not have enough salespeople available to provide service to all customers. The interactive system 10 of the invention allows a dealership to maximize “after hours” traffic as well traffic that is not otherwise adequately assisted during the busiest parts of the day by providing such customers with verbal information about the vehicles that they are interested in. The system 10 provides verbal product information 22 to these customers, thus servicing customers that would otherwise not receive complete information about the vehicles that they are interested in. While providing this additional service to customers, the interactive system 10 simultaneously allows the dealer to develop a database 16 of customer contact information and to use the database 16 to provide off-hours customers with additional information, such as in the form of mailings.

The various features of the system will now be described in detail.

A. Entering vehicle Information Into the System

As previously described herein, data may be entered into the system in any number of ways. In certain embodiments, the data entry procedure is automated. However, in other embodiments, each client of the interactive system 10 submits information about each product 24, such as a vehicle, that the client would like to place on the system 10. The information about each vehicle is stored in a central database 16 that is accessible through the web-based system 10. As further described herein, information about a particular vehicle may be submitted by the client by filling out and submitting a Vehicle Submission Form.

In some embodiments, the information includes: type of vehicle (e.g. passenger car, or truck), stock number, year, make, model, mileage, exterior color, price, status, date received in system, light description, and incentives. When a customer enters the nine digit product code 20 for a particular vehicle into the system 10, the system 10 converts the product information 22 on the form into a verbal message, through the routines shown in FIG. 1B. As indicated, each item input by the client preferably has a drop down menu box, which helps ensure that entries are consistent.

Each time a client submits a new product 24, such as a vehicle, to the system 10, the system 10 generates a unique product code 20, or vehicle code. Again, in certain embodiments, the product code 20 may be nine digits. While in other embodiments, the product code 20 may be from about four to about twelve digits. The product code 20 is automatically attached to the information submitted for that particular product 24. If a client needs to modify the product information 22 about a particular product 24, the client can log into the system 10 over a secure connection using a user ID and password, pull up the information for the selected vehicle, and then add, delete and modify information as needed. Product information 22 about a particular product 24 can be retrieved using the product code 20 assigned to that particular product 24 or by running queries in the database 16 (e.g. by make and year).

Using a vehicle as an example of a product 24, the system 10 preferably provides for re-use of the product codes 20 of vehicles which have been sold, or are otherwise no longer for sale. Once a vehicle is taken into the sold area, the system 10 needs to release the sequential number and allow it to be re-assigned in the future. The system 10 will still retain information about the number of days each vehicle was active (i.e. for sale on the system) before it was moved to another section.

Vehicles can be removed from the system 10 after they have been sold or are otherwise no longer for sale. The removal feature will preferably be simple to use, and preferably will be analogous to the “delete” function on a computer. Removal maybe accomplished through the “status” pull down menu. After the client selects the removal option, a “confirmation box” will appear on the client's computer screen to allow the client to confirm that it wants to move the vehicle to the “sold area.” The client/dealer will be able to search vehicles that have been removed to sold using all information on the submission form along with other information of how many times it was pulled up by a customer and so forth. The interactive system 10 also provides data on which vehicles sold most quickly. This information can help dealers maintain an inventory of vehicles that are likely to appeal to its particular customer base.

B. Customer Telephone Calls

1. Processing of Telephone Calls

In the interactive system 10, customer telephone calls are used both to provide customers with product information 22 and to develop a customer database 16 for use in marketing. As discussed above, each product is assigned a unique product code 20 which may have a number of digits from 4-12. Each car also has a telephone number 18 posted on it, along with instructions for placing a phone call in order to learn more about the car. When an after-hours customer sees a vehicle that he or she is interested in, the customer calls the telephone number 18. When a customer calls the telephone number 18, the customer is prompted to input his or her 10-digit home number, zip code and a voice clip of his or her name and address.

A voice clip is preferably used in lieu of voice transcription (i.e. use of voice transcription technology to convert the customer's verbal input into text at the time of the call), because existing voice transcription technology is not currently accurate enough to provide a desired level of functionality of the system. With a recorded voice clip, there is a good chance that the client or a third party transcriber can accurately decipher the name and address recorded in the voice message. In a preferred embodiment, transcription is carried out by a transcriber, thus relieving the client of this administrative task. The transcriber can be a third party or can be an in-house department of the system administrator. New or unprocessed voice clips are preferably posted to a secure location of the system 10. The transcriber has access to the unprocessed voice clips, such as through an on-line login process. The transcriber assigns one or more individuals to listen to each unprocessed voice clip, type out the voice clip message into text format, and enter the textual information into selected locations of the system 10.

In addition, the interactive system 10 collects each product code 20 of every product 24, such as a vehicle, that the customer is interested in, and also preferably records the date of the call, the time of call, and the length of the call. In certain embodiments, after a customer inputs the product code 20 for a particular vehicle, the interactive system 10 retrieves the textual information for that particular vehicle from the central database 16 of the system 10 via HTTP, converts the information from text-to-verbal message instantaneously, and reads the textual information to the customer in a verbal format. Additionally, the interactive system 10 also uses ANI to record the caller's telephone number, thus providing backup information in the event of errors in the voice message or in the client's input of the telephone number using his or her telephone key pad. However, as noted above, ANI is not always accurate, since a customer may be calling from someone else's telephone number. Between the voice clip, key pad entry and ANI, the odds of the system 10 missing a telephone number are very low compared to prior art systems.

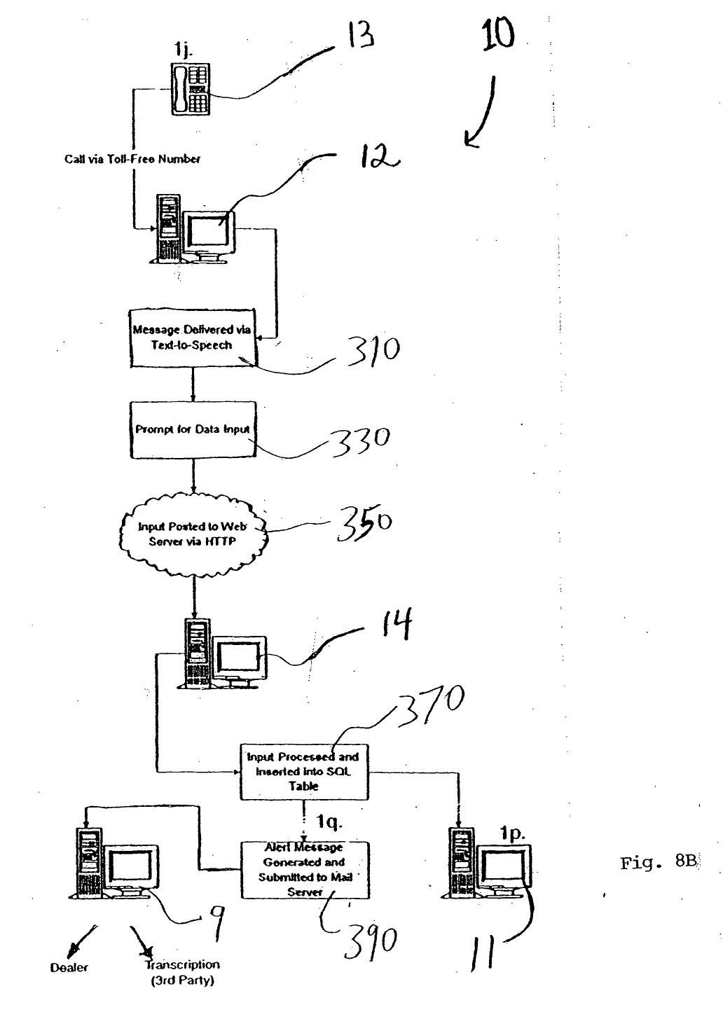

For certain embodiments, FIG. 8B shows initial processing of a customer telephone call over a customer's telephone. As shown in FIG. 8B, the call is made from a telephone 13 using a toll free telephone number 18. In a preferred embodiment, the toll free number 18 remains the same for all clients of the interactive system 10. In other words, a unique toll free number 18 is not assigned to each client. The IVR server 12 receives the call by use of the toll free telephone number 18. In certain embodiments, the IVR server 12 provides the customer with an initial greeting 310, which is conveyed via a Text-to-Speech function. Because there is only one toll free number for the interactive system 10, the system 10 greeting is static for every client on the system. Following the initial greeting 310, the system 10 prompts for data inputs 330 from the customer. The system verbally requests that the customer input information such as product codes 20, voice clips, keyed in zip codes and 10-digit home number. The information entered by the customer is then posted to the web server 14 via HTTP. The web server 14 then sends the processed information and inserts the information into an SQL table. The information is then sent to two places: (1) the SQL Server 11 which stores the data in the central database 16; and (2) an alert message 390 is generated and submitted to a mail server 9. The mail server 9 then sends an alert to the transcriber and the client that a contact has been made. The alert message is preferably an email message. The alert contains all relevant information about the customer.

As mentioned above, the IVR server 12 greeting 310 is a static script, i.e. a different greeting is not provided for each client of the system 10. The verbal greeting will be easy to understand. Once the verbal greeting has been played, the interactive system 10 relies heavily on interaction from the customer. A preferred procedure is for the interactive system 10 to request a voice clip of first name, last name, and street address, or all of these, followed by input of the customer's zip code and the telephone number via the customer's telephone key pad, though not necessarily in this order. A sample of a preferred script for the initial customer greeting is as follows:
“Thank you for calling the 24-hour Vehicle Information Hot-line. This system will allow you to learn about the vehicles on our lot. Before we begin, we would like to send you more information on the vehicles that you select during this call. To do this, we need you to clearly speak your first and last name after the tone.

Thank you. We now need your mailing address so we can send you information about the vehicles you are interested in. Please clearly state your complete street address, including city and state now. Please use your telephone key pad to press in your zip code, followed by the # sign. Finally, please punch in your 10-digit home phone number followed by the # sign. Thank you. Now, using your telephone key pad, please press the product code of the first vehicle that you would like more information about, followed by the # sign.”

For certain embodiments, FIG. 8A provides a high level flow chart of the process that the system 10 runs through once a customer enters 85 a product code 20 into the system 10. The customer inputs the product code 20 via the IVR server 12 using a telephone key pad. The product code 20 is then submitted through Hyper Text Transfer Protocol (HTTP) from the web server via the Internet 31. The web server then receives a “get” request 50. The server sends a request via SQL SELECT Query to the Central Database 16 for information about the selected vehicle. The HTTP Posts to the IVR Server 12 via the internet 70. Within this embodiment, the method is through ASCII or text format containing the vehicle information, with the IVR server 12 receiving the post 110. The IVR server 12 receives the post from the web server and “reads” vehicle information via Text-to-Speech so that the customer hears information about the vehicle posted via the Internet. The textual information about each vehicle is preferably entered into the database 16 by the client, although the client can elect to delegate this function to the system administrator or to a third-party.

FIG. 6 includes a flow diagram of an embodiment of customer requests for information from the system 10 through an IVR server 12, as discussed above. All requests will go through the HTTP Post to Web Server via the internet 95. The SQL INSERT Query inserts data into the system that is necessary for identification of the customer. This information is stored in the central database 16. The IVR server 12 entry point 96 does not provide the customer with access to the reports and related information (600 thru 900) that are available to the client on the system 10.

2. Failure of Customer to Provide All Requested Information

In some cases, the customer may not provide all of the information requested during the greeting sequence or the voice clip may contain mumbled or garbled information. If the customer inputs the customer's 10 digit phone number and zip code, the interactive system 10 can use this information to perform a reverse look up to obtain the name of the caller. A reverse lookup is preferably accomplished by sending the customer's zip code and phone number to a transcriber (third party), which uses an outside database to match the name of the customer to the phone number and zip code provided. A reverse lookup is preferably used only if the customer does not provide all of the required information or if the information on the customer's voice clip is undecipherable. Unlike the prior art, the interactive system 10 of the invention does not use ANI to perform the reverse lookup, but instead uses the information that the customer entered using the keypad of the customer's telephone. If the customer declines to provide all of the requested information, the system 10 can re-prompt the customer to supply the additional information. Optionally, the system 10 can terminate a call if the customer declines to provide complete information.

3. Text-To-Verbal Message Processing

In certain embodiments, once the customer has selected a product 24, such as a vehicle, by entering the product code 20, the system 10 sends to the customer information about the product 24 over the telephone using IVR technology. Information about the product 24 is obtained from text that the client stored in the central database 16. As previously described, the system 10 converts the textual information into voice output, which can be heard by the customer over the customer's telephone.

The use of text-to-verbal message functionality provides several advantages over the prior art. Compared with recorded verbal messages, text messages are less expensive to prepare and much easier to enter into the system 10. Text messages are easier to edit, easier to remove, and generally require fewer steps and less administration. For example, if a dealer notices that the make and model of a particular vehicle was entered incorrectly, the dealer simply pulls up the text of the vehicle message and types in the correct information. Because the system 10 is internet based, the correction can be made from any computer that has access to the system 10. When errors appear in a recorded verbal message of the type used in prior art systems, the entire message must be re-recorded in order to correct the error. If the verbal recording is being made by a third-party or at an off-site facility, the process can be time consuming and relatively expensive. Additionally, text-to-verbal messaging technology eliminates user based problems, such as accents and dialects, mumbling, poor recordings and the like, all of which can result in lost information, failure to build or maintain customer interest, and, consequently, loss of sales.

4. Customer Inquiries Over a Web-Site

In certain embodiments, as shown in FIG. 6, the interactive system 10 of the invention preferably includes a publicly accessible website for pre-owned and new vehicles. Through the web-site 97, all information about vehicles on a dealer's lot that have been entered into the system 10 can be accessed by the general public with no additional effort on the part of the dealer. The web-site allows customers to view vehicles by make, model, price, city and state, by zip code, or by like indicators so as to facilitate effective use of the system by customers. Once the customer selects a particular vehicle, the customer will be provided with a textual form of the dealer's description of the vehicle, along with information such as make, model, year and mileage, exterior color, price range, year range, 9 digit product code 20, and dealer. The internet entry point does not provide the customer with access to the reports and related information (600 thru 900) that are available to the client on the system 10.

C. Processing and Using Customer Data

The interactive system 10 uses information gathered from the customer's responses and stores the information in a central database 16 for future report generating. Customer information is stored in the central database 16 and is also sent by electronic mail to the client and transcriber (third party) upon completion of the call. The transcriber or the client transcribes the information and stores it for future use, such as for a follow up mailing. The interactive system 10 provides analytical functionality, so that the client can mine and analyze the data in selected formats. The interactive system 10 preferably generates reports using the end user responses and client text submission forms. The client can use the reports to manage vehicle inventory, analyze data concerning most popular vehicles, sold vehicles, price ranges, dates and times of calls, number of calls per day, mileage ranges, year, make and model. The client can access the system from conventional internet connections, and the client can thus access the information in the database 16 and the system from any location that has an internet connection. In other embodiments, clients can also access the system using PDAs and such other mobile internet connections methods as may be developed from time-to-time. The interactive system 10 reduces floor plan costs by creating better inventory balance on the lot and increasing the effectiveness of direct marketing campaigns through the creation of a solid and useful database of individuals. Details of certain embodiments of the system 10 will now be described.

FIG. 6 shows the three primary interactive functionalities of the system 10. These include dealer login 1010, Request from IVR 96 and Request from the Web 97.

The dealer login 1010 application allows the client to use a password and user name to access all of their information. Access to the website is controlled by a client ID number and a password. The system 10 allows each client to view and analyze information for the benefit of their business. This website ensures that all of the client's pertinent information is organized in a very manageable and informative method.

The login verification function 1030 is only available through the web site and will ensure that only the right client is accessing their private information. In certain embodiments, the SQL SELECT Query (Structured Query Language) sends a “retrieve message” to the central database 16. The Central database 16 will be responsible for keeping all information and for providing methods of querying from the client.

1. Inquiry Queue Reports

A client can perform several types of queries. The first description is the Inquiry Queue 600 (Default View). The client will see this screen when they access the web-based central database 16. This Inquiry Queue shows all leads which have not been processed 620, processed, 640 and test drive requests 660. The default view stores this information so that the next time a client accesses the application, the foregoing information will appear on the client's computer screen.

2. Inventory Administration

The Inventory Administration 700 allows the client to browse 710 the client's current inventory on the central database 16, add new vehicles, modify information about vehicles in the system 10, and delete vehicles from the system 10. The Inventory Administration 700 feature allows the client to readily stay informed of which vehicles and associated vehicle information are in the system, which assists in keeping inventory accurate.

3. Inventory Reports

The Inventory Reports 800 feature allows each client to run special reports on the client's current inventory 810 in the database 16. There are several ways to run Inventory Reports 800, such as vehicle type (passenger, sport utility, sports car, truck, van), Year, Make and Model. The client can also selectively run reports on mileage range of vehicles and status of the vehicle (i.e. sold or available).

4. Inquiry Reports

Another section of the figure is the Inquiry Reports 900. Inquiry Reports 900 allow the client to run reports 910 based on inquiry information from the customer and information from the submission report. Inquiry reports 900 are preferably by date/time, zip code, vehicle type, year, make, and model, and mileage and price range. Other reports can be modified and added as the system 10, or the client's use of the system 10, develops further.

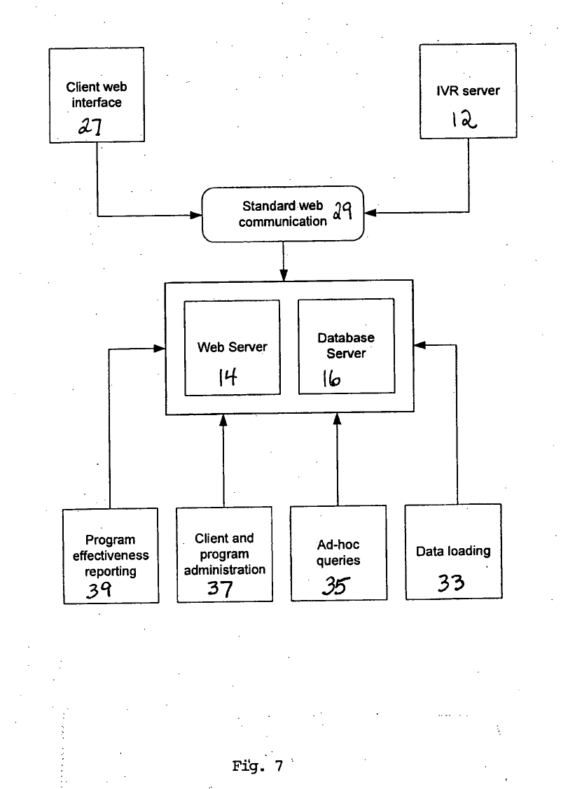

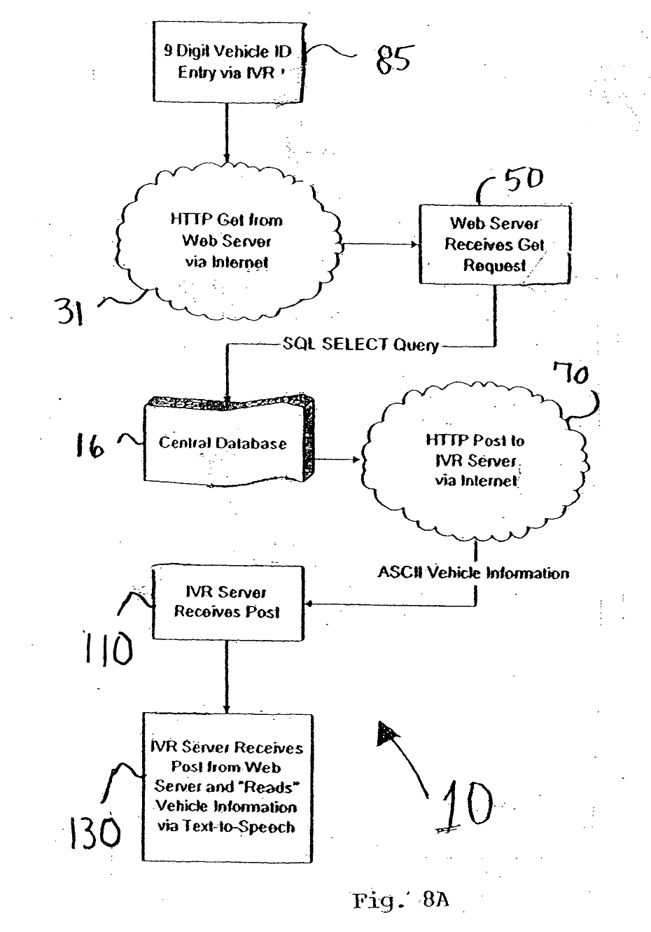

Referring now to FIG. 7, there is shown a flow chart showing the interaction of the web server 14 and database 16, which make up the core of the system 10. These two pieces work together as one unit. As seen in FIG. 7, clients have a web interface 27 they can use to interact with the servers. This allows for customization of product information 22 of each product 24, as well as allowing the client to obtain pre-made reports to show information about the advertising campaign. These reports may include information such as the number of calls during a day, number of calls grouped by hour or number of inquiries regarding a particular product 24. Note that the client interface 27 and IVR server 12 use standard web communication 29 protocol (HTTP) to communicate with the web server 14 and database 16.

Also seen in FIG. 7 are several other interfaces. Those interfaces include data loading 33, in which client data is transformed into a standard file format and then programmatically parsed, validated and loaded. Also, ad-hoc queries 35, standard SQL (structured query language) interface tools may be used to connect and allow retrieval of data in form or fashion not readily available in standard reports. Client and program administration 37 allows modification and control of information regarding clients. This information includes standard contract information as well as currently subscribed programs and access to the system 10. Client access can be deactivated at the end of the advertising campaign or prematurely if a need arises. Finally, program effectiveness reporting 39 allows the system to generate and document leads. For example, reports measuring the effectiveness of a particular advertising campaign may be prepared. This measurement uses the clients data and can then be used to enhance performance.

5. Email to Client

The system 10 converts the customer's data into an email, which is immediately forwarded to the client who is selling the selected vehicle. This feature provides a real-time lead on each incoming call. All leads will be on email the next morning when the manager comes to work and posted to the web site on the central database. Alternatively, rather than sending emails, the system 10 can send an alert to the client informing the client that it has new leads that have not been checked, in order to prompt the client to log into the system and check the leads. The alert can include a link to the system 10 web-site.

The real-time email lead can be sent to the client. Voice clips may be posted to a secure area of the system 10 web-site that is accessible by a third party transcriber. The sound clip can be transcribed by the client or the transcriber. The sound clip is uploaded to the website for updating. This will be done within 24 hours of each lead.

The email and website may include all the following information, including information captured from the customer: Dealer Name; Dealer Address; Dealer Phone Number; Dealer Contact; Date of Call; Time of Call; Duration of Call; Sound Clip of customer's name; Sound Clip of customer's address; Zip code (captured by telephone key pad); ANI number (number captured when calling the toll-free number); 10-Digit Home Phone number (captured by telephone key pad); information about each vehicle selected by the caller, i.e. Vehicle 1 (9 digit vehicle code; stock number; year, make and model), Vehicle 2 (9 digit vehicle code; stock number; year, make and model), etc. The stock number will not be on the voice clip that the customer hears, but will be available to the dealer via website searches.

D. Advertising

The interactive system 10 provides various features that can be used in advertising the client's products. The interactive system 10 is set up to receive several calls at one time and to process and store all collected data in an organized manner. Advertising is not required, because dealers can elect to rely on location traffic (i.e. visits to the dealer's lot) to generate calls. As discussed below, customers who visit the dealer's lot obtain product codes 20 for selected vehicles along with the toll free number 18 from the supplied vehicle tags. If the dealer elects to use the interactive system 10 in their advertising, they can use the same product codes 20 listed on the tags for their newspaper advertisements, as discussed below. Additional advertising, such as use of the product code 20 in advertising, will result in additional traffic from customers who respond to the advertising.

1. Follow Up Correspondence to Customer

For each lead captured into the central database 16, the client can elect to send a follow-up mailing to the customer's address. In certain embodiments, the system 10 is preferably configured such that the mail out is automatically prepared by the system, thus relieving clients of this administrative task, as shown in FIG. 4. The mail out contains information about each vehicle that the customer requested information about through entry of product codes 20. The mail out may contain a photograph of the customer's selected vehicles. The name, address, phone number, date of call placed, and time of call may be provided on the mail out. The mail out correspondence can include an incentive such as a discount voucher if the customer responds to the dealership by a certain date.

2. Use of Interactive System in Advertising

The system 10 of the invention is preferably used in the dealer's conventional print advertising. Use of the Hot-line can significantly reduce the cost of classified advertising because the dealer need only include the year, make, model, and the product code 20 in print advertisements, which reduces the amount of information in the classified advertisement and thus the price of the advertising. The classified ad can also include the toll free number 18 for the 24 hour automated hot-line and the dealer's logo. In display advertisements, the vehicles can be listed by year, make and model, and product code 24.

FIGS. 2, 3, 5A, and 5B provide examples of print advertisements that take advantage of the features of the invention. The print advertisements include a telephone number 18 that a customer can call to access the interactive system 10 of the invention. As previously mentioned, this telephone number 18 is preferably the only telephone number that allows customers to access the system. The print advertisements may also includes the product code 20 for the product.

3. Use of the Interactive System with Vehicle Tags

FIGS. 5A and 5B are a format for a vehicle tag for use with the interactive system 10. For many years, dealers have provided all new and pre-owned vehicles with a tag explaining the information about the vehicle. The tag information that must be provided for new vehicles is established by law and cannot be altered. However, tags for pre-owned vehicles can be modified to provide limited information about the vehicles, such as year, make, model and stock number. Providing limited tag information will encourage customers to call into the interactive system 10 using the 24 Hour telephone number 18 in order to obtain additional information. The vehicle tag shown provides all of the information necessary to entice a customer to call into the system 10: such as telephone number 18; product code 20; price; year; make; stock number and model. In alternate embodiments, additional information may be provided. Each vehicle in inventory may also be provided with a large window sticker that states something to the effect of: “If you would like more information on this vehicle, please call our 24 hour/7 day a week, 100% Automated Hot-Line.”

The system 10 is preferably configured so that tags can be readily printed by the client using conventional personal computers and associated printers (e.g. laser printers). Pre-printed tags can be provided. When a submission form is submitted, the client is provided with an option for a “print tag” button or substantially similar functionality. Upon selecting the print tag option, the client will be prompted or reminded to put the pre-printed tags into the printer before printing begins. The system 10 preferably allows the client/user to select whether to print the vehicle tags individually or as a group (i.e. all at once). The system 10 also preferably provides an option for re-printing tags as needed, since tags will inevitably become lost, misplaced, or require updating.

4. Providing Advertising Information to Print Media

Each dealer typically has a method of providing selected newspapers and other print media with a list of vehicles that the dealer would like to advertise in the newspaper(s). Through use of the present invention, dealers and newspapers can automate the process so that less time is spent processing advertising information and the newspapers receive advertising information in a more organized format. The interactive system 10 web-site can include a program that can be emailed to the newspaper. This program allows the dealer to have consistent pricing for both programs. The dealer can even do searches by vehicles, print out a list, cross off vehicles they do not want to advertise, and send to the newspaper. The program makes the ad submission process more efficient and accurate, thus saving time and money.

In this detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

All references, publications, and patents disclosed herein are expressly incorporated by reference.

Thus, it is seen that the system and method of the present invention readily achieves the ends and advantages mentioned as well as those inherent therein. While certain preferred embodiments of the invention have been illustrated and described for purposes of the present disclosure, numerous changes in the arrangement and construction of parts may be made by those skilled in the art, which changes are encompassed within the scope and spirit of the present invention as defined by the following claims.

1. A method of selling products by providing a web-based interactive system that provides a plurality of customers with product information while simultaneously providing a plurality of clients of the interactive system with a database of customer information, comprising:
providing a plurality of product codes,
storing each said product code in association with product information about a product item of a client of the system, said product information comprising textual information,
providing a telephone number, said telephone number providing access to an IVR server,
recording a textual greeting in a database, said database accessible to said IVR server,
processing a plurality of telephone calls received from customers via said telephone number, each said processing step comprising:
playing a verbal customer greeting to the customer, said customer greeting soliciting input from the customer,
receiving, in response to said customer greeting, a textual set of customer contact information from the customer via customer input using a key pad of the customer's telephone,
storing said textual set of contact information,
receiving, in response to said customer greeting, a verbal set of customer contact information from the customer via the customer speaking into the customer's telephone,
storing said verbal set of customer contact information in a voice clip,
receiving, in response to said greeting, one or more selected product codes from the customer, the customer selecting said product codes via customer input over the customer's telephone,
in response to each said selected product code, playing verbal information about said product item associated with said product code to the customer, wherein said playing of information is accomplished by said system converting said textual information about said product item into a verbal format,
providing a plurality of clients with login access to said system.

2. The method of claim 1, wherein said textual set of customer contact information further comprises the customer's telephone number and zip code, wherein the verbal set of customer contact information further comprises the customer's name, address, and telephone number.

3. The method of claim 1, further comprising manually processing each verbal set of customer contact information in order to convert the information into a textual format, and associating the textual format with the customer in the system.

4. The method of claim 1, further comprising mailing the customer information about the product items that the customer selected during the telephone call via input of the product codes.

5. An interactive method of generating leads, comprising:
receiving a telephone call of a user;
receiving a product code entered by the user;
validating the product code against product codes in a database;
collecting information from the user;
storing the information from the user in the database;
forwarding the information to a client, wherein the information is forwarded in textual form;
providing product information to the user by a voice message; and
terminating the telephone call.

6. The method of claim 5, wherein the information forwarded in textual form further comprises forwarding an email.

7. An interactive method of gathering information for a sales lead, comprising:
receiving a telephone call from a caller by an interactive voice response server;
providing verbal information to the caller from the interactive voice response server;
contacting a web server by the interactive voice response server;
building script by the web server;
receiving caller information, wherein the caller information further comprises a product number;
validating the caller information by the web server;
storing in a database the caller information; and
sending the caller information to a client.

8. The method of claim 7, further comprising entering verbal information by a client.

9. The method of claim 7, wherein receiving a telephone call further comprises receiving a plurality of telephone calls simultaneously.

10. The method of claim 7, wherein the caller information further comprises a contact telephone number, and contact mailing address.

11. The method of claim 10, further comprising preparing a follow up letter to the caller from the client.
